(19) United States
(12) Patent Application Publication
(10) Pub. No.: US 2026/0171464 A1
(43) Pub. Date: Jun. 18, 2026

(54) BATTERY PACK SYSTEM WITH END-PLATES FOR INTERNAL PRESSURE DISTRIBUTION

(71) Applicants: HYUNDAI MOTOR COMPANY, Seoul (KR); KIA CORPORATION, Seoul (KR)

(72) Inventors: Junyoung Kang, Hwaseong-si (KR); Seok Eun Yoon, Hwaseong-si (KR); Young Hoo Oh, Hwaseong-si (KR)

(73) Assignees: HYUNDAI MOTOR COMPANY, Seoul (KR); KIA CORPORATION, Seoul (KR)

(21) Appl. No.: 19/195,221

(22) Filed: Apr. 30, 2025

(30) Foreign Application Priority Data
Dec. 17, 2024 (KR) 10-2024-0189064

(51) Int. Cl. H01M 10/04; H01M 50/204; H01M 50/242; H01M 50/244; H01M 50/262; H01M 50/289

(52) U.S. Cl. CPC H01M 10/0468; H01M 50/242; H01M 50/244; H01M 50/262; H01M 50/289; H01M 50/204

(57) ABSTRACT

A battery pack system includes a plurality of battery modules with stacked battery cells. The plurality of battery modules is secured to multiple seating portions in a battery housing. The housing includes a base plate forming its bottom surface, from which multiple transverse members protrude upward, running parallel to each other. A set of longitudinal members intersects these transverse members, creating defined seating portions. Two end-plates are connected to the transverse members, forming parallel side walls. The distance between the end-plates'facing pressing surfaces is precisely adjusted and fixed.

### CROSS-REFERENCE TO RELATED APPLICATION(S)

This application is based on and claims the benefit of and priority, under 35 U.S.C. 119, to Korean Patent Application No. 10-2024-0189064, filed on Dec. 17, 2024, in the Korean Intellectual Property Office, the disclosure of which is herein incorporated by reference in its entirety.

### TECHNICAL FIELD

The present disclosure relates to a battery pack system with end-plates for internal pressure distribution, and more particularly to a battery pack system configured such that surface pressure is uniformly applied to battery modules disposed with high density in a battery housing.

### BACKGROUND

Battery pack systems are widely used in various fields such as electric vehicles, energy storage systems (ESSs), and home appliances.

The conventional battery pack systems may be categorized by coupling units, such as a battery module, a battery array, and a battery cell.

Each battery cell is usually formed in the shape of a plate.

Battery cells are stacked one above another such that wide surfaces are in contact with each other to form a battery module in a predetermined number of units.

Battery cells may be assembled in a stacked structure and densely packed to have high energy density per unit area.

In order to achieve high energy density in a limited space, however, thermal expansion, shock, vibration, and load between the battery cells must be carefully analyzed. Each battery module and battery system must be designed based on the results of analysis.

Battery pack systems are constantly charged and discharged due to the nature thereof. This causes each battery cell to undergo micro-expansion and contraction.

In addition, as a result of repeated charging and discharging, a large number of battery modules integrated in the battery housing undergoes physical and chemical changes and ages.

It is very natural for some of the battery modules to deteriorate as the battery modules are repeatedly charged and discharged and as the period of use increases.

Therefore, it is necessary to propose technology for designing a more stable battery pack structure having a long lifespan by solving these problems.

### SUMMARY

It is an object of the present disclosure to solve a conventional problem that the physical lifespan of a battery pack system is reduced due to the concentration of the force that couples and fixes battery cells and/or battery modules in a part of the battery pack system.

It is another object of the present disclosure to solve a conventional problem that a battery housing is designed with a structure that is complex and difficult to manufacture to increase durability of the interior of the battery housing or an additional device is required to provide additional durability.

It is a further object of the present disclosure to solve a conventional problem that the maintenance and repair of battery modules coupled in a complex structure requires a complex and time-consuming process of disconnecting and reconnecting individual battery modules.

Therefore, if pressure can be uniformly distributed over the surface of each of the battery modules installed in the battery housing, if stress can be prevented from being concentrated in some regions, or if the temperature of each battery cell can be easily controlled by structurally preventing heat generation, the lifespan of a battery pack system may be significantly increased.

Objects of the present disclosure are not limited to the aforementioned objects, and other unmentioned objects of the present disclosure should be clearly understood from the following description.

A battery pack system according to an embodiment of the present disclosure includes a battery module, a battery housing, a base plate, a transverse member, a longitudinal member, and an end plate.

The battery module may include a plurality of battery cells coupled in a multilayer stacked structure. The battery housing may have seating portions of a predetermined size provided therein, and the battery module may be seated in each of the seating portions. The base plate may form a bottom surface of the battery housing, and the base plate may be a plate-shaped member. A plurality of transverse members may be disposed parallel to each other as partitions upwardly protruding straight along an upper surface of the base plate. A plurality of longitudinal members may intersect the transverse members so as to form the plurality of lattice-shaped seating portions as partitions upwardly protruding straight along the upper surface of the base plate. A pair of end-plates may be connected to both ends of the transverse members to form both side walls parallel to each other, and the distance between pressing surfaces facing each other at both ends of the transverse members may be adjusted and fixed.

In the battery pack system according to an embodiment of the present disclosure, the battery housing may include a pair of side wall portions, which are wall structures configured to be coupled and separated along both side ends of the base plate, and an installation end extending outward from each of the side wall portions and having at least one expansion coupling dock.

Alternatively, in the battery pack system according to an embodiment of the present disclosure, the pair of end-plates may be installed inside the pair of side wall portions, respectively, and each of the end-plates may be spaced apart from a corresponding one of the side wall portions adjacent thereto by a predetermined distance.

In the battery pack system according to an embodiment of the present disclosure, each of the end-plates may include a guide slot into which at least a part of one end of each of the transverse members is inserted so as to intersect vertically, and the guide slot may be formed at the position vertically corresponding to the end of each of the transverse members.

Alternatively, in the battery pack system according to an embodiment of the present disclosure, each of the end-plates may include an exposed surface opposite the pressing surface, the exposed surface being disposed toward an opposite side to the seating portion, and a plurality of protruding ribs protruding from the exposed surface in a normal direction, the protruding ribs being disposed in a transverse direction.

In the battery pack system according to an embodiment of the present disclosure, each of the end-plates may include a plate-shaped loop connector protruding horizontally from the exposed surface along an upper end of each of the guide slots in the normal direction so as to have a predetermined area, and each of the end-plates may have a larger length in an upward-downward direction than the transverse members such that an upper end thereof is more highly formed, each of the guide slots being opened toward a lower part of the end-plate.

Alternatively, in the battery pack system according to an embodiment of the present disclosure, each of the transverse members may include an intersecting end formed low at a constant height in a predetermined region from each of both ends thereof, a guide surface, which is an upper surface formed flat at the intersecting end, and at least one vertical coupling hole provided in the guide surface.

In the battery pack system according to an embodiment of the present disclosure, the guide slot may be shaped and sized to correspond to the intersecting end, the intersecting end extending through the guide slot and being orthogonal to the end-plate, the loop connector may include a corresponding coupling hole, which is a through-hole formed above the vertical coupling hole, the vertical coupling hole and the corresponding coupling hole being disposed up and down, and the battery pack system may further include a vertical coupling member extending through the corresponding coupling hole and the vertical coupling hole to couple the corresponding coupling hole and the vertical coupling hole to each other.

Alternatively, in the battery pack system according to an embodiment of the present disclosure, the corresponding coupling hole may be formed as a long hole having a predetermined length extending in a longitudinal direction of the transverse member.

In the battery pack system according to an embodiment of the present disclosure, the intersecting end may include a protector extending upward while wrapping around at least a part of an outer periphery of an end of the guide surface end and pressing ends connected to both sides of the protector and having edges formed perpendicular to the exposed surface of the end-plate along both side ends of the guide surface.

Alternatively, in the battery pack system according to an embodiment of the present disclosure, the protruding ribs may further include reinforcement surfaces configured to connect ends of at least two protruding ribs up and down.

In the battery pack system according to an embodiment of the present disclosure, the protruding ribs may protrude so as to have a predetermined shape pattern in the normal direction of the exposed surface.

Alternatively, in the battery pack system according to an embodiment of the present disclosure, the protruding ribs may have at least two different heights protruding from the exposed surface.

In the battery pack system according to an embodiment of the present disclosure, the protruding ribs may have at least two different thicknesses.

### BRIEF DESCRIPTION OF THE DRAWINGS

The above and other features of the present disclosure are described below in detail with reference to certain embodiments thereof illustrated in the accompanying drawings which are given herein below by way of illustration only, and thus are not limitative of the present disclosure, and wherein:

FIG. 1 is a view showing a structure for fixing a plurality of battery modules in a conventional battery pack system;

FIG. 2 is a sectional view illustrating the internal structure of a battery pack system according to an embodiment of the present disclosure;

FIG. 3 is a partial sectional view illustrating the structure of a seating portion to which a battery module is coupled in the battery pack system according to an embodiment of the present disclosure;

FIG. 4 is a front view of an end-plate configured to apply surface pressure in the battery pack system according to an embodiment of the present disclosure;

FIG. 5 is a partial sectional view showing the structure in which the end-plate is coupled to an end of a transverse member forming a plurality of seating portions together with a longitudinal member in the battery pack system according to an embodiment of the present disclosure;

FIGS. 6 and 7 are state views showing a process in which the end-plate is assembled along one side end of each of a plurality of transverse members in the battery pack system according to an embodiment of the present disclosure;

FIG. 8 is a schematic view illustrating the structure in which the end-plate is coupled to the end of each transverse member in the battery pack system according to an embodiment of the present disclosure; and

FIG. 9 is a partial perspective view showing coupling between the end of a transverse member and an end-plate in a battery pack system according to another embodiment of the present disclosure.

### DETAILED DESCRIPTION

Hereinafter, embodiments disclosed herein are described in detail with reference to the accompanying drawings.

Identical or similar components are denoted by identical or similar reference numerals, and redundant descriptions may be omitted.

When a component is referred to as being “connected” or “coupled” to another component, the component may be directly connected or coupled to the other component or there may be other components therebetween.

On the other hand, when a component is referred to as being “directly connected” or “directly coupled” to another component, it is meant that there is no other component therebetween.

In this specification, the term “including” or “having” indicates the presence of the features, steps, operations, components, parts, or combinations thereof described herein, without excluding any one thereof.

When a part, component, unit, device, element, or the like of the present disclosure is described as having a purpose or performing an operation, function, or the like, the part, component, unit, device, or element should be considered herein as being “configured to” meet that purpose or to perform that operation or function.

A first direction (X-axis direction), a second direction (Y-axis direction), and a third direction (Z-axis direction) described herein are used to describe a solid shape in a three-dimensional space, and are orthogonal to each other.

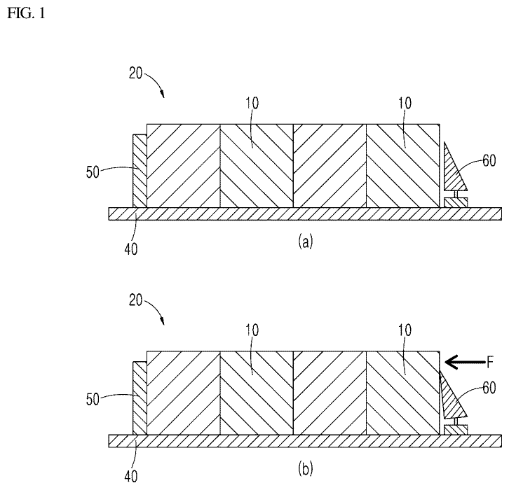

FIG. 1 is a view showing a structure for fixing a plurality of battery modules 20 in a conventional battery pack system.

As shown in FIG. 1, the battery module 20 includes a plurality of battery cells 10. The battery cells 10 are generally flat, plate-shaped structures that overlap and are coupled to each other in a stacked structure. A coupling unit including a plurality of battery cells 10 coupled in a stacked structure is referred to as a battery module 20.

A battery pack system means that a plurality of battery modules 20 is densely installed in a predetermined space.

The battery modules 20 may be received in a predetermined space, such as between or within a seating structure 40 and a fixing member 50. External force may be applied to each battery module 20 by a pressing member 60 for fixation.

However, as shown, the conventional battery pack system has a structure in which the physical force applied to the battery modules 20 and the battery cells 10 is not uniformly distributed.

Therefore, there is often a small gap between some of the battery modules 20 or the battery cells 10, and some regions are subjected to higher pressure than surrounding regions, resulting in a decrease in the efficiency of the battery pack.

The present disclosure relates to a battery pack system with end-plates 500 for internal pressure distribution.

In an example of the present disclosure, a plurality of battery modules 20, each including a plurality of battery cells 10 coupled in a stacked structure, is received, and surface pressure is distributed to securely and stably support the battery modules 20. The battery pack system according to an example of the present disclosure includes a battery housing 30 in which the battery modules 20 can be seated with high energy density. Seating portions 32 that hold the battery modules 20 in a grid-shaped arrangement are formed in the battery housing 30.

The battery modules 20 fixed to the seating portions 32 may receive surface pressure uniformly distributed facing inwardly from both ends from the end-plates 500.

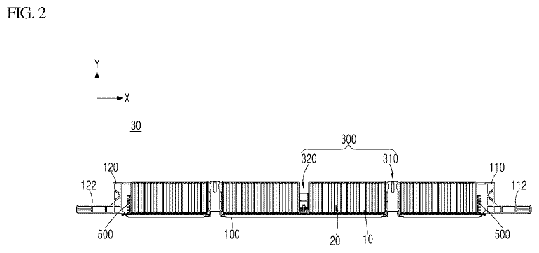

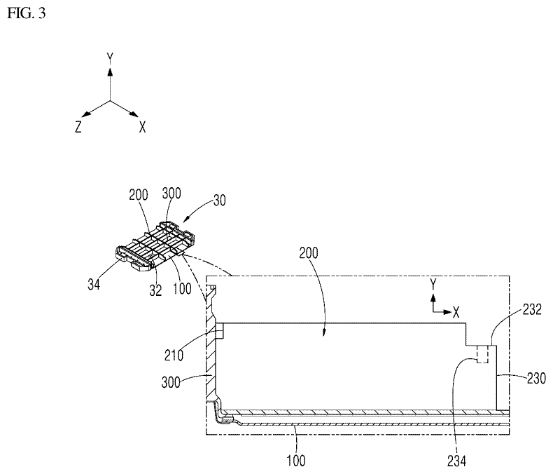

FIG. 2 is a sectional view illustrating the internal structure of a battery pack system according to an embodiment of the present disclosure. FIG. 3 is a partial sectional view illustrating the structure of a seating portion 32 to which a battery module 20 is coupled in the battery pack system according to an embodiment of the present disclosure.

As shown in FIGS. 2 and 3, the battery pack system according to an embodiment of the present disclosure includes a battery module 20, a battery housing 30, a base plate 100, a transverse member 200, a longitudinal member 300, and an end-plate 500.

The battery module 20 is a unit structure in which a plurality of battery cells 10 is electrically connected in series or parallel and which is designed to have predetermined voltage and capacity.

A battery cell 10 is a basic unit for storing electrochemical energy. The battery cells 10 may be implemented in various forms, such as a lithium-ion battery or a lithium-polymer battery.

Each battery cell 10 has a certain standard, voltage, and capacity. The battery cell 10 generally has a structure in which a positive electrode, a negative electrode, an electrolyte, and a separator are received in an aluminum or steel plate case.

Each battery module 20 is constituted by battery cells 10 stacked so as to have multiple layers. An insulator or buffer pad is interposed between each of the battery cells 10 to protect the battery cell 10 from electrical short circuit or shock.

A separate case or frame structure may be further coupled to the outside of the battery module 20.

The battery housing 30 has a partition structure in which a plurality of partitioned seating portions 32 is formed, as shown.

The base plate 100 forms a bottom surface of a lower end of the battery housing 30. The base plate 100 is a plate-shaped structure provided on a flat surface of the lower end of the battery housing 30 to support parts loaded thereon.

The transverse member 200 and the longitudinal member 300 are installed on an upper surface of the base plate 100.

The transverse member 200 and the longitudinal member 300 protrude vertically upward from the upper surface of the base plate 100 to partition a space.

A plurality of transverse members 200 is disposed on the upper surface of the base plate 100 in parallel, and a plurality of longitudinal members 300, which perpendicularly intersect the transverse members 200, is disposed on the upper surface of the base plate 100 in parallel.

The plurality of intersecting transverse members 200 and the plurality of longitudinal members 300, which intersect each other, form grid-shaped seating portions 32 that occupy the majority of the upper surface of the base plate 100.

Each of the seating portions 32 is a space which is formed by the upper surface of the base plate 100 constituting a bottom surface and a pair of transverse members 200 and a pair of longitudinal members 300 constituting four side walls and in which a battery module 20 is received and mounted.

Each of the transverse members 200 and the longitudinal members 300 may be made of metal or rigid composite plastic to withstand shock or vibration.

The longitudinal member 300 may be divided into a fixing unit 310 formed to be durable and resistant to external force and a functional unit 320 manufactured to facilitate assembly or to perform a predetermined function.

A plurality of predetermined-sized seating portions 32 is provided in the battery housing 30. A battery module 20 is seated in each of the seating portions 32, and the battery module 20 coupled to each of the seating portions 32 is disposed such that the stacked surfaces of the battery cells 10 provided therein are oriented in a certain direction.

A first side wall portion 110 and a second side wall portion 120 forming both side surfaces of the battery housing 30 along both side ends of the base plate 100 may be further provided.

The first side wall portion 110 and the second side wall portion 120 may be coupled to and separated from the base plate 100 on both sides of the battery housing 30, respectively.

The first side wall portion 110 and the second side wall portion 120 may include a first installation end 112 and/or a second installation end 122 having a predetermined shape and size.

The first installation end 112 and/or the second installation end 122 may be provided with at least one expansion coupling dock.

The expansion coupling dock provided on the first installation end 112 and/or the second installation end 122 may be fastened to a separate external structure, a chassis of a vehicle, or the like.

In addition, the battery housing 30 may further include a link module 34 configured to transmit and receive electrical energy, a refrigerant, or data to and from the outside (i.e., outside the vehicle).

A pair of end-plates 500 is provided inside the first side wall portion 110 and the second side wall portion 120, respectively.

The end-plates 500 may be coupled to both ends of the transverse members 200. The end-plates 500 stably fix both ends of the plurality of transverse members 200.

The end-plates 500 may have flat pressing surfaces 510 formed on inner surfaces that face each other.

Thus, by adjusting and fixing the distance between the pressing surfaces 510, which are flat surfaces that face each other, the plurality of battery modules 20 disposed therebetween may be fixed at a constant surface pressure.

The end-plates 500 may be installed inside the first side wall portion 110 and the second side wall portion 120, respectively, and a predetermined distance may be formed between each of the side wall portions 110 and 120 and a corresponding one of the end-plates 500.

The spaces formed between one end-plate 500 and the first side wall portion 110 and between the other end-plate 500 and the second side wall portion 120 are provided for flexible response to micro-deformation of the battery cell 10 or battery module 20, manufacturing dimensional deviation, thermal expansion due to charging and discharging, and the like.

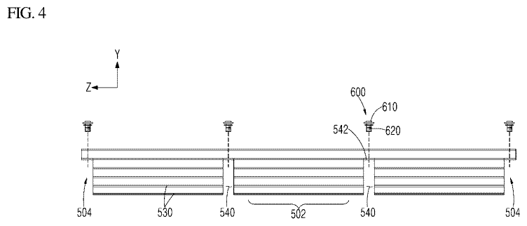

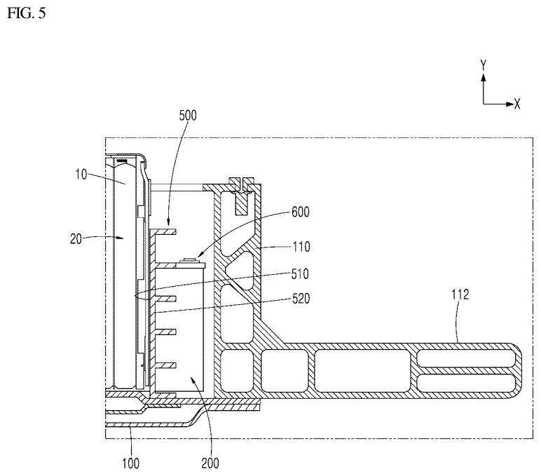

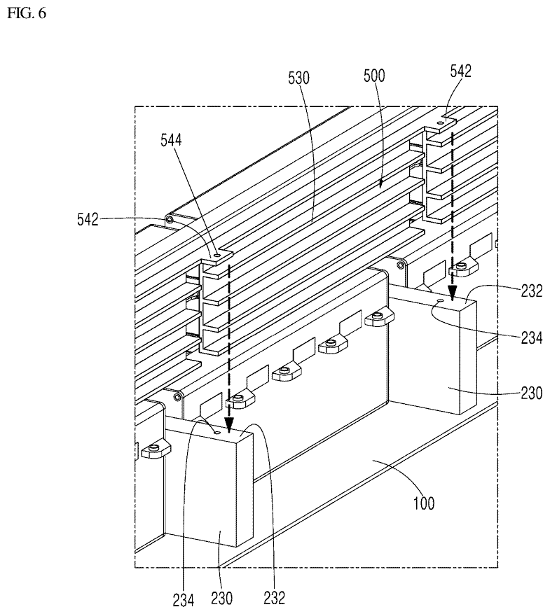

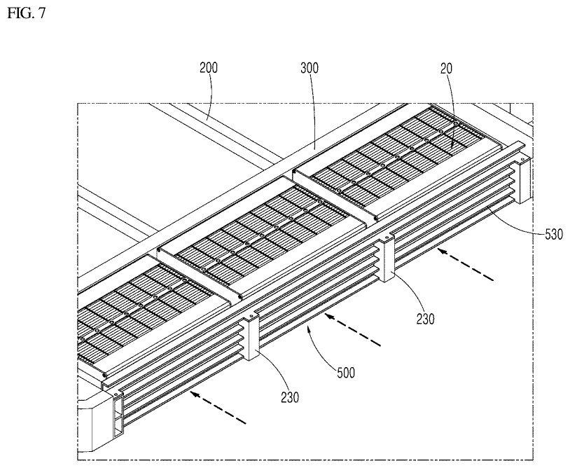

FIG. 4 is a front view of the end-plate 500 configured to apply surface pressure in the battery pack system according to an embodiment of the present disclosure. FIG. 5 is a partial sectional view showing the structure in which the end-plate 500 is coupled to the end of the transverse member 200 forming the plurality of seating portions 32 together with the longitudinal member 300 in the battery pack system according to an embodiment of the present disclosure. FIGS. 6 and 7 are state views showing a process in which the end-plate 500 is assembled along one side end of each of the plurality of transverse members 200 in the battery pack system according to an embodiment of the present disclosure.

As shown in FIGS. 4-7, each end-plate 500 may be made of a metal or composite material that is highly rigid and resistant to deformation.

Each end-plate 500 is a plate-shaped member having a large area along a Y-Z plane. The end-plate 500 includes a pressing surface 510, which is a flat surface, and an exposed surface 520, which is a surface opposite the pressing surface 510 and faces outward relative to the position of the seating portions 32 (i.e., the exposed surface 520 faces away from the seating portions 32).

A plurality of guide slots 540 is formed in the end-plate 500. Each of the guide slots 540 is shaped to allow at least a part of one end of a corresponding transverse member 200 to extend therethrough in a vertical direction.

The number, position, interval, and the like of the guide slots 540 may be determined based on the number of transverse members 200 provided in an embodiment of the present disclosure and the position in which both side ends thereof are viewed vertically.

The guide slot 540 may be an open space in the form of a slot with both side walls and an upper surface formed in an open configuration facing downward from a lower end of the end-plate 500.

The exposed surface 520 of the end-plate 500 may be provided with a plurality of protruding ribs 530.

Each protruding rib 530 may be provided as a transversely oriented straight reinforcement plate that protrudes from the exposed surface 520 in a normal direction (i.e., perpendicular to the exposed surface 520).

As shown, the plurality of protruding ribs 530 may be formed on the exposed surface 520 in parallel in a transverse direction, and some of the protruding ribs 530 may omit a part of the region where the guide slots 540 are formed in the end-plate 500.

The plurality of protruding ribs 530 protruding from the exposed surface 520 of the end-plate 500 may be configured to increase the structural rigidity of the end-plate 500 and to rapidly dissipate internal heat.

The guide slots 540 are slot-shaped openings formed in the end-plate 500, and allow intersecting ends 230 formed at the ends of the transverse members 200 to be vertically inserted and extend therethrough.

The transverse member 200 has a coupling groove 210 formed for cross-coupling with the longitudinal member 300 and a pair of intersecting ends 230 formed at both ends.

The intersecting ends 230 are formed at the ends of the transverse member 200, and each of the intersecting ends 230 includes a region having a uniformly low height.

In an embodiment of the present disclosure, the end-plates 500 are higher than the transverse members 200 such that the upper end of each of the end-plates 500 is disposed higher than the transverse members 200.

Each of the intersecting ends 230 provided on the transverse member extends vertically through a corresponding one of the guide slots 540 formed in the end-plate 500 so as to be coupled thereto.

The intersecting end 230 may have a rectangular section, and the uniformly low upper surface thereof is a flat guide surface 232, in which at least one vertical coupling hole 234 may be formed.

Alternatively, depending on embodiments to which the present disclosure is applied, the guide surface 232 may be provided with a plurality of vertical coupling holes 234 formed at predetermined intervals in a longitudinal direction.

Each of the guide slots 540 formed in the end-plate 500 is provided with a loop connector 542, which is a plate-shaped member that projects forwardly of the exposed surface 520 along an upper end thereof. The loop connector 542 may abut an upper part of the guide surface 232 formed at the intersecting end 230 of the transverse member 200 corresponding thereto.

The loop connector 542 may be provided with at least one corresponding coupling hole 544, and the corresponding coupling hole 544 and the vertical coupling hole 234 may be disposed and aligned in an up and down (i.e., vertical) orientation such that the positions thereof are fixed through a vertical fastening member 600. In other words, the at least one corresponding coupling hole 544 and the vertical coupling hole 234 are vertically aligned.

The vertical coupling hole 234 formed in the guide surface 232 may be further provided with a pop nut made of a highly elastic material to increase fixing force applied to the outer circumference of a fastening pin 620 of the vertical fastening member 600.

The vertical fastening member 600 has a wide fastening head 610, which downwardly presses an upper surface of the loop connector 542 such that a lower surface of the loop connector 542 and the guide surface 232 are securely fixed in a state of abutting each other.

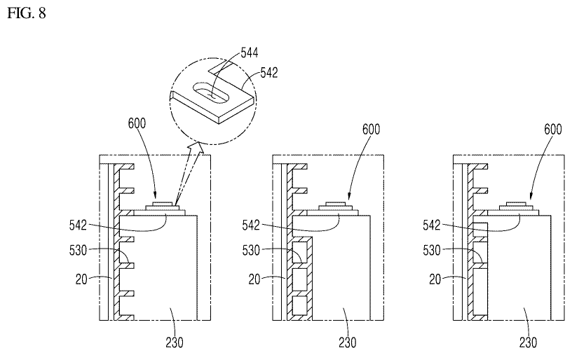

FIG. 8 is a schematic view illustrating the structure in which the end-plate 500 is coupled to the end of each transverse member 200 in the battery pack system according to an embodiment of the present disclosure.

As shown in FIG. 8, in the battery pack system according to an embodiment of the present disclosure, the corresponding coupling hole 544 of the loop connector 542 provided at the upper end of each of the guide slots 540 may be formed as a long hole (or short slot) open in one direction.

In this case, a longitudinal direction of the corresponding coupling hole 544 may be parallel to a normal direction of the pressing surface 510 provided on the end-plate 500.

The corresponding coupling hole 544 having a predetermined length resists expansion or deformation that may occur through the battery modules 20, and the positions at which the end-plate 500 and the intersecting ends 230 are fixed slide in the transverse direction to prevent great pressure from being applied to a specific battery module 20 or battery cell 10.

In addition, as shown, the plurality of protruding ribs 530 formed on the exposed surface 520 may have the same length (height), but the ends of at least two of the protruding ribs 530 may be connected to each other as reinforcement surfaces configured to increase structural rigidity.

Each of the protruding ribs 530 may be formed so as to have at least two different lengths (heights) protruding from the exposed surface 520, and the protruding ribs 530 may be formed so as to have at least two different thicknesses.

Alternatively, the protruding ribs 530 may be formed on the exposed surface 520 so as to protrude according to a series of patterns, such as a predetermined shape.

Depending on embodiments to which the present disclosure is applied, each of the protruding ribs 530 formed on the exposed surface 520 may be formed such that a central portion 502 and both side end portions 504 have different heights or thicknesses.

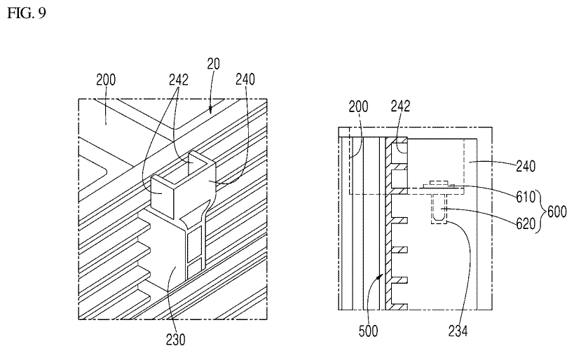

FIG. 9 is a partial perspective view showing coupling between the end of a transverse member 200 and an end-plate 500 in a battery pack system according to another embodiment of the present disclosure.

As shown in FIG. 9, in the battery pack system according to the other embodiment of the present disclosure, an intersecting end 230 formed on each transverse member 200 may be further provided with a plate-shaped protector 240 extending upward from an end of a guide surface 232 thereof.

The protector 240 may extend upward from the end of the guide surface 232 to physically protect a vertical fastening member 600 fastened to a loop connector 542 from the outside.

In addition, plate-shaped members extending from both sides of the protector 240 along both side ends of the guide surface 232 may be further provided.

The plate-shaped member formed along each of both side ends of the guide surface 232 and extending from the protector 240 may be provided as a pressing end 242 having an end edge elongated in a vertical direction and directly facing the exposed surface 520.

In this case, the guide surface 232 may be formed between the pressing end 242 and the middle of the transverse member 200 so as to have a predetermined distance, and the end-plates 500 may be assembled such that the end-plates 500 move downward from above when coupled to both ends of the plurality of transverse members 200 and regions in which the intersecting ends 230 and the guide surfaces 232 are formed and guide slots 540 vertically intersect each other.

According to the present disclosure, the lifespan of a battery pack system may be improved by distributing the pressure applied to battery modules or battery cells coupled to a battery housing such that the pressure can be uniformly applied thereto.

According to the present disclosure, it is possible to shorten the manufacturing cycle time and to reduce production costs by ensuring that uniform surface pressure is applied to the battery modules without adding an additional part or manufacturing process to the battery housing.

According to the present disclosure, a pair of end-plates has a structure capable of pressing a plurality of battery modules disposed therebetween with distributed force while allowing enough space in the battery housing to respond to external force or deformation of the battery cells.

According to the present disclosure, it is possible to further improve the stability of the battery pack system by enabling the end-plates securing the battery cells or battery modules on both sides to move in response to deformation of some of the battery cells or the battery modules.

Effects of the present disclosure are not limited to the aforementioned effects, and other unmentioned effects of the present disclosure should be clearly understood by those having ordinary skill in the art from the above description.

Embodiments of the present disclosure have been described above with reference to the drawings. The described embodiments and the drawings are given by way of example, and it is understood that the present disclosure can be variously modified within the scope of the disclosed technical ideas.

The described embodiments are to be considered as part of the present disclosure, and the scope of the present disclosure is not limited to the described embodiments.

The scope of the present disclosure is to be determined by the technical ideas recited in the claims.

Even if the described embodiments do not explicitly describe the operation or effect of a specific construction, the operation or effect that can be predicted by the construction is within the scope of the present disclosure.

What is claimed is:

1. A battery pack system comprising:
a plurality of battery modules, each battery module of the plurality of battery modules comprising a plurality of battery cells coupled in a multilayer stacked structure;
a battery housing having a plurality of seating portions of a predetermined size provided therein, each battery module of the plurality of battery modules being seated in a corresponding seating portion of the plurality of seating portions;
a base plate configured to form a bottom surface of the battery housing, the base plate being a plate-shaped member;
a plurality of transverse members disposed parallel to each other and upwardly protruding from an upper surface of the base plate;
a plurality of longitudinal members intersecting the plurality of transverse members to form the plurality of seating portions, the plurality of longitudinal members being parallel to each other and upwardly protruding from the upper surface of the base plate; and
a pair of end-plates adjustably connected at opposite ends of the transverse members, the pair of end-plates being parallel to each other and having pressing surfaces facing each other, wherein a distance between the pressing surfaces is adjustable.

2. The battery pack system according to claim 1, wherein the battery housing
comprises:
a pair of side wall portions configured to be coupled and separated along respective ends of the base plate; and
an installation end extending outward from each of the side wall portions.

3. The battery pack system according to claim 2, wherein the pair of end-plates is installed between the plurality of battery modules and the pair of side wall portions, respectively, and wherein each of the end-plates is spaced apart from a corresponding side wall portion of the pair of side wall portions adjacent thereto by a predetermined distance.

4. The battery pack system according to claim 1, wherein each of the end-plates comprises:
an exposed surface opposite a pressing surface, the exposed surface facing away from the plurality of seating portions; and
a plurality of protruding ribs protruding from the exposed surface in a normal direction, the protruding ribs being disposed in a transverse direction relative the end-plates.

5. The battery pack system according to claim 4, wherein
each of the end-plates comprises a plate-shaped loop connector protruding horizontally from the exposed surface in the normal direction, the plate-shaped loop connector having a predetermined area.

6. The battery pack system according to claim 4, wherein
each of the end-plates comprises a guide slot configured to receive at least a part of one end of a transverse member of the plurality of transverse members, and
the guide slot is positioned to vertically correspond to the end of the transverse member.

7. The battery pack system according to claim 6, wherein each of the plurality of transverse members comprises:
an intersecting end having a constant height in a predetermined region from each of both ends thereof;
a guide surface, the guide surface being a flat upper surface formed at the intersecting end; and
at least one vertical coupling hole provided in the guide surface.

8. The battery pack system according to claim 7, wherein the intersecting end comprises:
a protector extending upward from and around at least a part of an outer periphery of an end of the guide surface; and
pressing ends connected to both sides of the protector and having edges formed perpendicular to the exposed surface of the end-plate along both side ends of the guide surface.

9. The battery pack system according to claim 7, wherein
the guide slot is shaped and sized to correspond to the intersecting end, the intersecting end extending through the guide slot and being orthogonal to the end-plate.

10. The battery pack system according to claim 6, wherein
each of the end-plates comprises a plate-shaped loop connector protruding horizontally along an upper end of each of the guide slots, the plate-shaped loop connector having a predetermined area.

11. The battery pack system according to claim 10, wherein
the loop connector comprises a corresponding coupling hole, the corresponding coupling hole being a through-hole formed above the vertical coupling hole, the vertical coupling hole and the corresponding coupling hole being vertically aligned, and
the battery pack system further comprises a vertical coupling member extending through the corresponding coupling hole and the vertical coupling hole to couple the corresponding coupling hole and the vertical coupling hole to each other.

12. The battery pack system according to claim 11, wherein the corresponding coupling hole is formed as a long hole having a predetermined length extending in a longitudinal direction relative to the plurality of transverse members.

13. The battery pack system according to claim 6, wherein each of the end-plates has a larger length in an upward-downward direction than the plurality of transverse members such that an upper end thereof is more highly formed, the guide slot being disposed toward a lower part of the end-plates.

14. The battery pack system according to claim 4, wherein the protruding ribs further comprise reinforcement surfaces configured to connect ends of at least two protruding ribs in a vertical direction.

15. The battery pack system according to claim 4, wherein the protruding ribs protrude so as to have a predetermined shape pattern in the normal direction of the exposed surface.

16. The battery pack system according to claim 4, wherein the protruding ribs have at least two different heights protruding from the exposed surface.

17. The battery pack system according to claim 4, wherein the protruding ribs have at least two different thicknesses.
